(19) United States
(12) Patent Application Publication
(10) Pub. No.: US 2025/0374280 A1
(43) Pub. Date: Dec. 4, 2025

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Vivek SHARMA, Basingstoke (GB); Yuxin WEI, Basingstoke (GB); Samuel Asangbeng ATUNGSIRI, Basingstoke (GB); Hideji WAKABAYASHI, Basingstoke (GB)

(73) Assignee: Sony Group Corporation, Tokyo (JP)

(21) Appl. No.: 18/875,367

(22) PCT Filed: Jun. 9, 2023
(86) PCT No.: PCT/EP2023/065530

§ 371 Date: Dec. 16, 2024

(30) Foreign Application Priority Data
Jun. 23, 2022 (EP) 22180836.3

(51) Int. Cl. H04W 72/21; H04W 72/1268

(52) U.S. Cl. CPC H04W 72/21; H04W 72/1268

(57) ABSTRACT

A method for operating a communications device in a wireless network involves transmitting uplink data using predetermined radio interface resources. The device determines uplink data availability and independently selects periodic uplink resource instances, each including data resources. The method includes transmitting the first part of the data with full control information specifying scheduling parameters and transmitting subsequent data parts with partial control information reflecting parameter changes. This approach allows efficient, autonomous uplink data transmission while adapting scheduling parameters to optimize network resource use.

### BACKGROUND

### Field of Disclosure

The present disclosure relates to communications devices, infrastructure equipment and methods for the more efficient operation of a communications device in a wireless communications network.

The present applications claims the Paris Convention priority from European patent application number EP22180836.3, filed on 23 Jun. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises determining that the communications device has uplink data to transmit to the wireless communications network, determining, independently from the wireless communications network, a plurality of periodically occurring instances of uplink resources of the wireless radio interface in which the uplink data is to be transmitted, wherein each of the instances of the uplink resources comprise at least a data resource, transmitting to the wireless communications network, in at least one of the instances of the uplink resources, a first part of the uplink data and full control information, and transmitting to the wireless communications network, in at least one other of the instances of the uplink resources, a second part of the uplink data and partial control information. Here, the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.

Embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates how different UEs can be assigned separate spatial-layer resources;

FIG. 5 illustrates how different UEs can be assigned separate frequency-domain resources;

FIG. 6 illustrates how different UEs can be assigned separate time-domain resources;

FIG. 7 shows an example of pre-assigned dedicated resources for UE-based scheduling comprising separate control and data resources;

FIG. 8 shows a part schematic, part message flow diagram representation of a wireless communications system comprising a communications device and an infrastructure equipment in accordance with embodiments of the present technique;

FIG. 9 illustrates an example of the adaptation of control information (payload) size for UE-based scheduling in accordance with embodiments of the present technique; and

FIG. 10 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

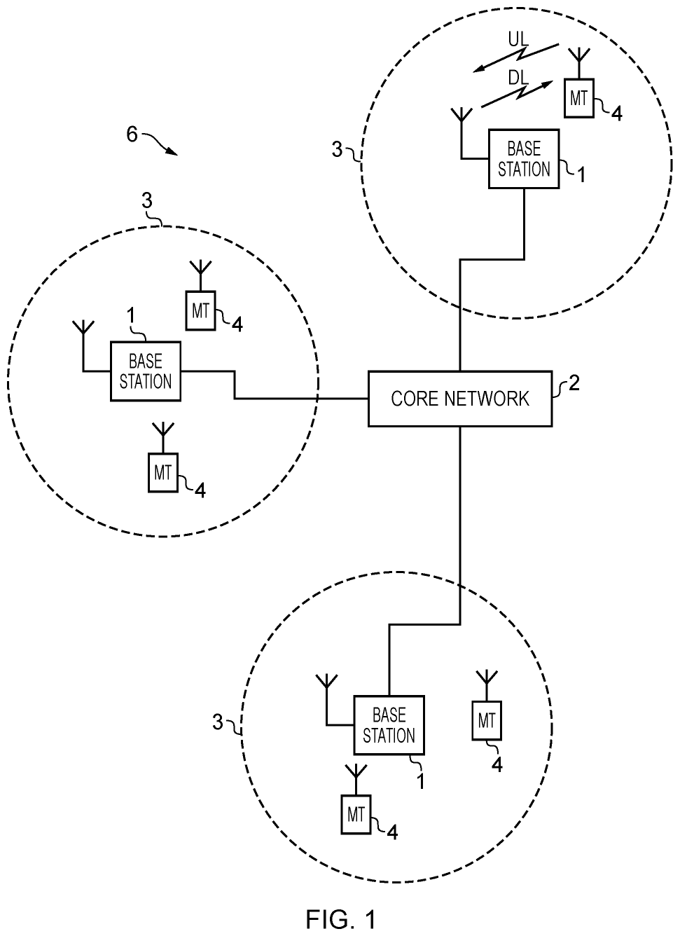

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

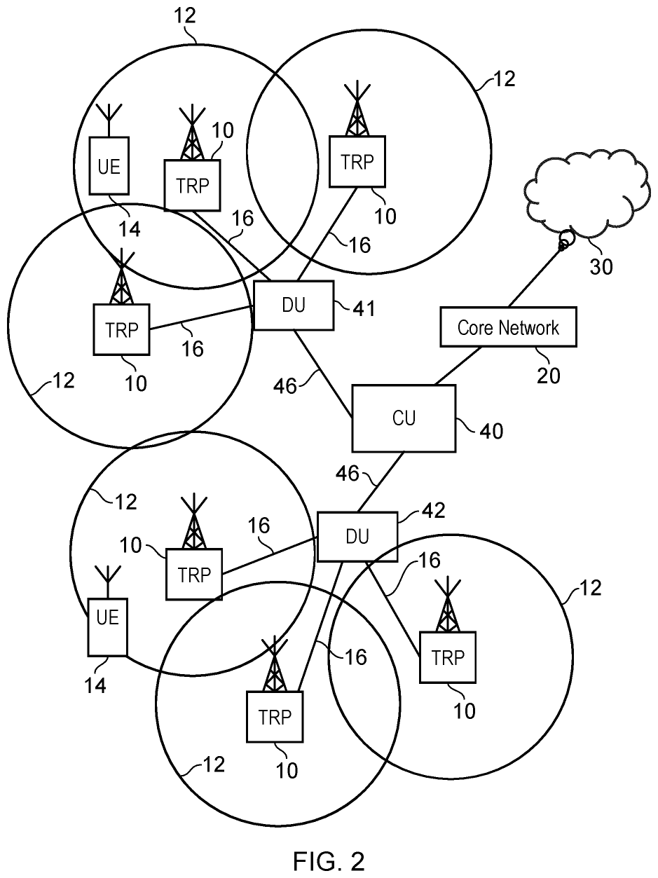

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface. each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2. and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus. certain embodiments of the disclosure as discussed herein may be implemented in wireless telecommunication systems/networks according to various different architectures. such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

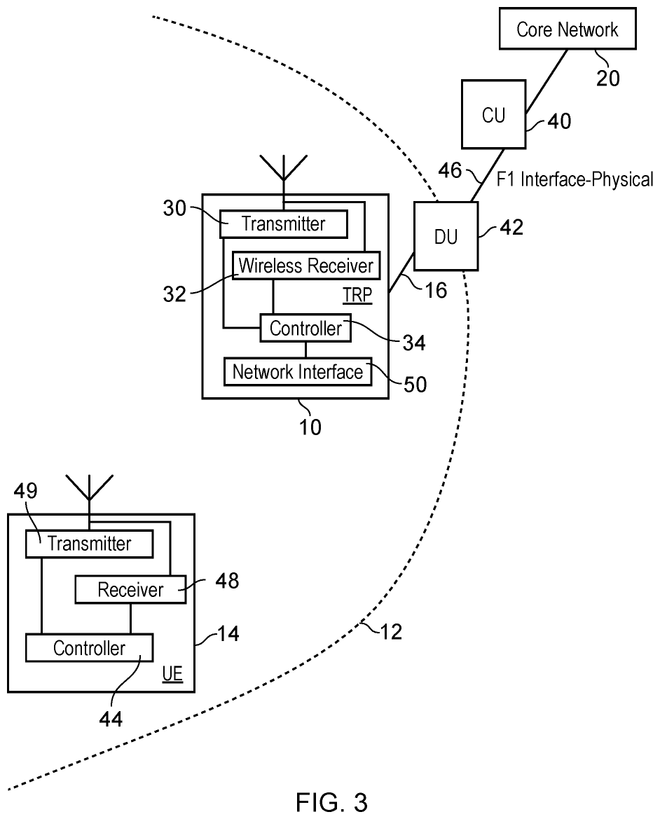

A more detailed diagram of some of the components of the network shown in FIG. 2 is provided by FIG. 3. In FIG, 3. a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium. such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### URLLC and eURLLC

Systems incorporating NR technology are expected to support different services (or types of services), which may be characterised by different requirements for latency. data rate and/or reliability. For example. Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4]. for which one of the objectives is to enhance UE feedback for Hybrid Automatic Repeat Request Acknowledgements (HARQ-ACK) for Physical Downlink Shared Channel (PDSCH) transmissions.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IIoT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS). Reduced Capability UEs, Vehicular Communications (V2X), Integrated Access and Backhaul (IAB), UE power saving. Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful.

A typical use case (e.g. for broadcast TV production) is a camera transmitting a video stream using the User Data Protocol (UDP)/Internet Protocol (IP) protocol stack. In layer 2 of this protocol stack (L2), Radio Link Control-Unacknowledged Mode (RLC-UM) mode will be configured for UDP. Accordingly, dedicated (and probably regular) resources may be configured by the network, using techniques like periodic UL grant or configured grant. Such techniques are already developed and available.

As an example scenario, there might be a video algorithm which requires a camera not to transmit any uplink video frames if the view does not change. But as soon as the view changes, video codecs will have data available for transmission in L2 buffers. If traditional techniques are relied upon, the camera/UE must request UL resources before transmitting on the uplink. This likely involves additional signalling and latency which is detrimental to live production.

In this case, the UE must wait for an UL slot to send a physical uplink control channel (PUCCH), where this PUCCH comprises a scheduling request (SR), and then must wait again for the network to receive this SR, allocate resources for the UE, and indicate this resource allocation within downlink control information (DCI) carried by a physical downlink control channel (PDCCH). Furthermore, the network does not necessarily know how much data is in the UE's buffer, and so can only schedule the UE for limited data, until the UE sends a buffer status report (BSR) via, for example, a physical uplink shared channel (PUSCH), and must wait again to be scheduled for a larger amount of data based on the BSR.

Further aspects of UL scheduling may be found in co-pending European patent application published under number EP3837895 [5]. the contents of which are hereby incorporated by reference.

### Link Adaptation in Existing Mobile Communications Networks

The lower layers (MAC and physical layers) of a mobile communication system are designed to create a radio waveform used for conveying data between a transmitter and receiver given some expected radio propagation conditions between the communicating gNB and the UE. In traditional link-layer designs, these layers are designed to allow the radio-communication system to cope with a given degree of radio propagation impairment. The success of mobile communication systems over the last few decades has been mainly due to the adoption of link adaptation that helps to maximise the throughput. In mobile communication systems such as 3G, 4G and 5G, the link-layer is designed with many choices for the forward error correction (FEC) code rates, modulation constellations, waveform type, transmit power levels. These can be jointly selected into sets of transmission parameters. Each set can be thought of as a parametrisation for the generation of the transmitted signal resulting from the joint choices that make the set. A given set is expected to generate a waveform or signal for transmission that is different from what another set would generate. Therefore, a deliberate choice can be made of a particular set of transmission parameters with the expectation that it would generate a transmission signal that is somehow more suitable for a prevailing set of radio channel propagation conditions than another set.

This method of designing link-layers is rather long-winded and laborious because it is difficult to deliberately determine the set of choices for all the configuration parameters. This is firstly, and especially, because the process of choosing between particular communication signal processing techniques such as FEC coding schemes (Low Density Parity Check (LDPC) codes. Turbo codes, or Polar codes, for example) is not trivial. Secondly, this is because even after a particular communication signal processing technique has been chosen, deciding on the set of possible configurations of the chosen technique that have to be designed and standardised is also an onerous process. As an example, if we consider only the FEC, then the radio communication system designer may have to first choose the FEC scheme (LDPC, Turbo or Polar codes etc.), then having chosen the FEC scheme, would need to then decide what block sizes and code rates to support etc. before proceeding to a similar process for modulation constellations etc.

Assuming that the radio-communication system has been designed already, such a system design has already chosen a coding scheme. In addition, it supports a designed number of possible codeword block sizes, a designed number of code rates per block size, a designed number of modulation constellations etc. Link adaptation allows the UE and gNB to work together to determine automatically:
1. The prevailing radio propagation conditions that will affect the transmitted data; and
2. The most appropriate set of link-layer configuration parameters (block size, code rate, modulation constellation etc.) to use so as to maximise throughput and/or transmission resource utilisation for the transmitted data within target reliability and/or latency under the prevailing radio propagation conditions.

This choice of an appropriate set of link-layer configuration parameters is also not trivial as it presents a somewhat multi-dimensional problem with the decision depending for example on the given transmission block size and the prevailing radio propagation channel conditions etc. Link adaptation in 4G and 5G systems is limited to the selection of a configuration from amongst a set of designed choices. For link adaptation of the downlink (DL), the UE measures channel quality parameters on the reception of reference signals transmitted by the BS. The channel quality is then signalled to the BS as a channel quality indicator (CQI) that can be either narrow band or wideband depending on the bandwidth of the reference signals used for its measurement. Based on this CQI report from the UE, the BS can adapt its DL transmissions to maximise throughput. Similarly, for the UL the BS measures channel quality parameters from reception of sounding reference signals (SRS) transmitted by the UE and uses the results of these measurements to instruct the UE how to adapt UL transmissions to maximise throughput. In 4G and 5G systems, since the FEC type for data channels is fixed, link adaptation therefore only involves the selection from a set of possible FEC code rates and modulation constellations—i.e. the modulation and coding scheme (MCS). Transmit power can also be thought of as an aspect of link adaptation, but is not typically adjusted per transmission block.

### Legacy Scheduling Methods in NR (5G)

In cellular wireless communications, the channel between a mobile terminal and the base-station experiences typically rapid and significant variations which impact the quality of the received signal. In the small-scale variation, the channel goes through frequency selective fading which results in rapid and random variations in the channel attenuation. In the large-scale variation, there are shadowing and distance related pathloss which affect the average received signal strength. In addition, there is interference arising from transmissions from nearby cells and terminals which distorts the signal at the receiver side.

In practice, the heart of mitigating and exploiting the variations of the channel condition is the scheduling mechanism that implements link adaptation algorithms, such as adaptive modulation and coding schemes (AMCS), dynamic power control and channel-dependent scheduling.

In NR, the downlink and uplink multi-user schedulers are located at the base-station (gNB) where, in principle, the scheduler assigns the resources for the users with the best channel conditions in a given instance in both the UL and DL while taking into account the fairness among users as well. There are two types of scheduling mechanism, and these are termed as dynamic scheduling (or dynamic grant) and semi-persistent scheduling (or configured grant).

In dynamic multi-user scheduling for downlink transmissions, based on the instantaneous channel condition where the terminal feeds back the channel quality indicator (CQI) derived from downlink reference signals (RS) at regular time-intervals to the gNB, the scheduler at the gNB, after receiving the CQI, decides the best modulation and coding scheme (MCS), best “available” frequency resources (physical resource blocks (PRBs)) and adequate power for the downlink data transmissions for some users at a given subframe/slot. The downlink scheduling decisions, which are known as scheduling assignments, are carried by downlink control information (DCI), which is transmitted in the downlink to the scheduled users.

Similarly, for the dynamic multi-user scheduling for uplink transmission, based on the instantaneous channel condition where the terminal sends channel SRS at regular time-intervals to the gNB, the scheduler at the gNB, after deriving the CQI based on the last received SRS, decides the best modulation and coding scheme, best frequency resources (PRBs) for the uplink data transmissions from some users at a given subframe/slot. The uplink scheduling decisions, which are also known as scheduling assignments, are carried by DCI which is transmitted in the downlink to the scheduled users.

For semi-persistent scheduling (SPS) however, the resources are pre-configured semi-statically (e.g. via radio resource control (RRC) signalling) with a certain periodicity, where this periodicity is aligned with the data arrival rate for a particular service. There is an SPS for the downlink (known as DL SPS) and an SPS for the uplink (referred to as configured grant (CG)).

CG resources are mainly intended to deliver multiple traffic classes in a timely manner from the terminal, where such traffic classes have low data rates and some kind of periodicity, as specified in URLLC/IIoT in NR Rel-16/17. Some examples of the different traffic classes include industrial automation (future factory), energy power distribution, and intelligent transport systems, voice.

### Issues with Legacy Scheduling Methods

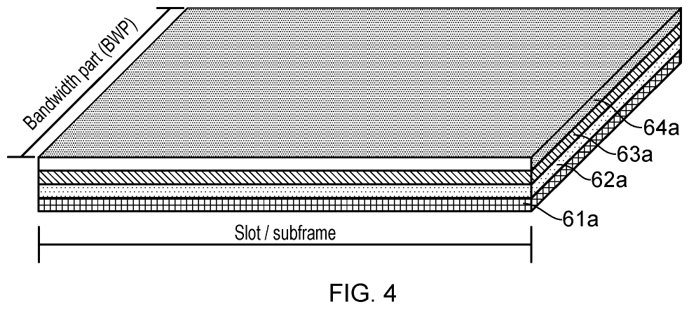

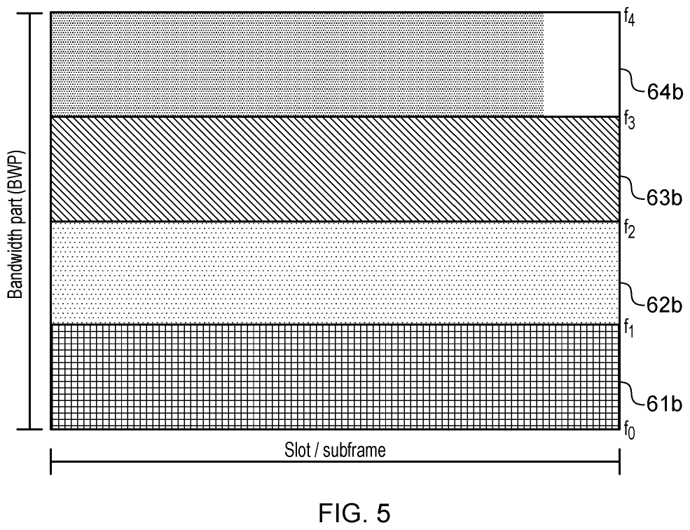

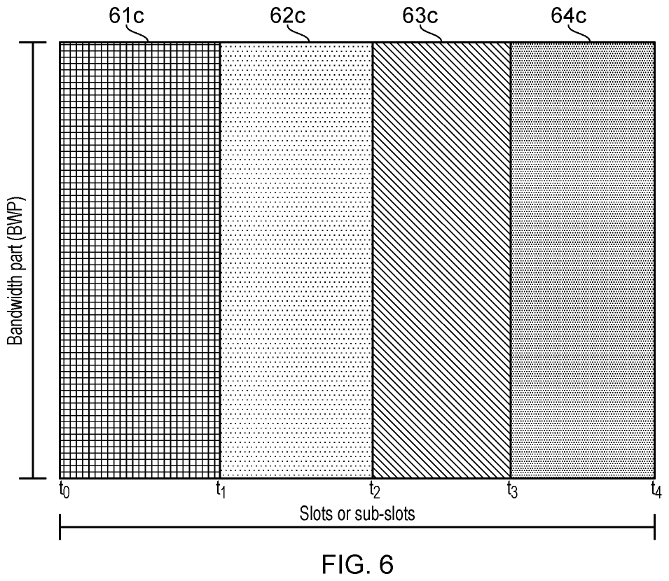

As described above, CG resources are mainly intended for traffic with a low data rate and with some kind of periodicity, as specified in URLLC/IIoT in NR Rel-16/17. However, for traffic with a high data rate and which requires low latency, larger resources would be needed. In this case, a UE can be pre-configured with dedicated larger resources for such uplink data transmissions. These resources can be allocated by one of the following methods (or by a combination of these methods):
Spatial-domain allocation: In this method, the gNB pre-allocates a specific spatial layer to the UE, where different UEs are allocated to different spatial layers in a bandwidth part (BWP), similar to multi-user multiple-input and multiple-output (MU-MIMO). This means that a UE has pre-allocated resources in the spatial-domain for both control and data. Hence, when the UE has data to transmit, the UE uses resources in the spatial layer reserved for it. The spatial-domain resource can be configured for a full set or a sub-set of the BWP resources during a given transmission time interval. As shown in the example in FIG. 4, a first UE may be assigned a first spatial layer 61a, a second UE may be assigned a second spatial layer 62a, a third UE may be assigned a third spatial layer 63a, and a fourth UE may be assigned a fourth spatial layer 64a in a slot;
Frequency-domain allocation: Similarly, to spatial-domain resources, dedicated frequency-domain resources can be pre-assigned to the UE where different UEs are allocated different frequency resources in a system bandwidth or a BWP during a given transmission time interval. Hence, when data arrives at the UE's buffer, the UE uses the frequency resources allocated for it. As shown in the example in FIG. 5, a first UE may be assigned a first frequency resource set 61b (i.e. frequency range f₀-f₁), a second UE may assigned a second frequency resource set 62b (i.e. frequency range f₁-f₂), a third UE may assigned a third frequency resource set 63b (i.e. frequency range f₂-f₃), and a fourth UE may assigned a fourth frequency resource set 64b (i.e. frequency range f₃-f₄); and
Time-domain allocation: Similarly, to both spatial and frequency-domain resources, dedicated time-domain resources can be pre-allocated for a UE where different UEs are allocated different time resources (e.g. different sub-slots or slots) in a component carrier or BWP. As shown in the example in FIG. 6, a first UE may be assigned a first time resource set 61c (i.e. time range t₀-t₁), a second UE2 may be assigned a second time resource set 62c (i.e. time range t₁-t₂), a third UE may be assigned a third time resource set 63c (i.e. time range t₂-t₃), and a fourth UE may be assigned a fourth time resource set 64c (i.e. time range t₃-t₄).

The first issue with using pre-configured dedicated resources for uplink data transmissions is that the resources are always reserved in advance, regardless of whether a UE actually has data to transmit or not. Even though a UE is able to release these pre-configured resources after finishing its UL data transmissions, the concern is that the signalling and commands for re-allocating/re-activating the resources will come from the network, which may result in some unbearable delays for a variety of services requiring for example high capacity URLLC on the uplink, and will also involve signaling from the UE to request resources either via a scheduling request (SR), or initiating a RACH procedure, or will involve resources being configured for idle periods (i.e. periods during which no transmissions are scheduled for a UE, but from which the UE can wake up immediately when necessary).

The second issue with pre-configured resources is that a UE may not be able to control completely the link adaptation parameters, such as frequency-domain scheduling, in order to choose the best frequency resources (PRBs) in a BWP, modulation and coding scheme (MCS), etc. Since the UE has to wait, after sending its measurements and/or SRS to the network, for the network to determine such link adaptation parameters and signal these to the UE, which both introduces latency and means that the most appropriate parameters may not be selected as the channel conditions may have changed between the time that the UE performed the measurements and/or transmitted the SRS and the time that the UE receives the link adaptation parameters from the gNB.

The third issue with pre-configured resources is that a UE may have to use all the resources whenever it has data to transmit, because the gNB and UE must each have knowledge of the allocated resources. This may mean that a UE must add padding bits in order to fill the remaining resources. This is clearly not desirable, as it increases the UE's transmission power consumption unnecessarily, and also generates interference for other UEs located in the same or a neighboring cells.

Accordingly, some enhancements for UL scheduling will be required for future mobile communications networks, such as 5G-Advanced and 6G. A set of requirements for such enhanced UL scheduling can be envisioned as listed below:
Immediate transmission of the UL data in order to reduce latency, for example for applications requiring heavy UL data with low latency;
Choosing appropriate link adaptation parameters, for example the best frequency resources (PRBs), MCS, power, etc.;
Flexible resource allocation scheme, for example frequency domain resource allocation (FDRA) and/or time domain resource allocation (TDRA);
An efficient way of identifying a UE and its resource allocation dynamically at the gNB receiver; and
Improving spectral efficiency of the cell, so that when a UE is not using its allocated resources, another UE could in principle use such resources.

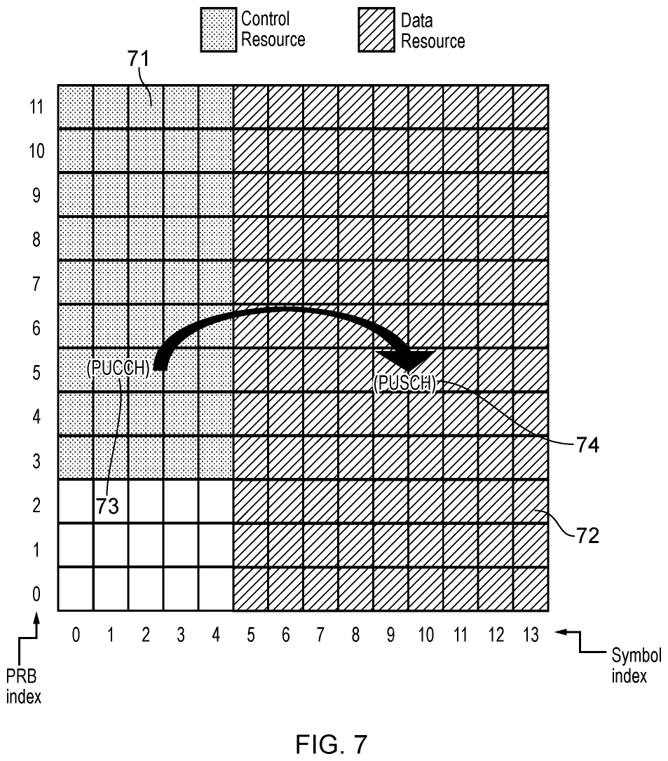

A solution to support UE-based scheduling in accordance with such requirements, where a UE is pre-assigned dedicated uplink resources for UL control and data transmissions in which these resources comprise UE-specific control resources and associated data resources, is provided in [5]. FIG. 7 illustrates an example of such separate control resources 71 and data resources 72 within pre-assigned dedicated resources for a UE, in accordance with what is described in [5].

Here, the UE takes control of its own scheduling decisions (or assignments) for its UL data transmissions, which are to be confined within the pre-assigned dedicated resources. The UE-specific control resource 71 is always available for scheduling the UL data on a specific BWP. Hence, this solution addresses the requirements captured above, including ensuring immediate UL data transmission, provision of appropriate link adaptation and a flexible resource allocation scheme, providing an efficient way of identifying the UE, and improving the spectral efficiency of the cell. In FIG. 7, as is described in [5], If the gNB decodes the PUCCH 73 received within the control resources 71, but not the PUSCH 74 received within the data resources 72, the gNB will send a negative acknowledgement (NACK) to the UE. Otherwise, the gNB will transmit a positive acknowledgement (ACK) to the UE indicating the successful decoding of the PUSCH.

Such solutions allow for the minimised delay at a UE when it has data to transmit with respect to legacy scheduling methods, as it does not have to wait to receive uplink grants from the network (and is not required to transmit a BSR for example in order to receive a grant large enough to transmit all of the data in its buffer). Some such solutions are described in co-pending European patent application number EP21204071.1 [6], the contents of which are hereby incorporated by reference. The concept of UE-based scheduling in [6] exploits configured grant (CG) resources, and such CG resources may comprise both a control part (e.g. for uplink control information (UCI) or other control information) and a data part. Here, as described in [6], this control part may be embedded in the CG PUSCH, or may be carried separately on a PUCCH, whilst the data part is transmitted on the CG PUSCH. One issue with such solutions however is that the transmission of the control part in each instance of the CG resources (as is the case in [6]) introduces constant overheads for the uplink transmissions as the control information (UCI) is always included in each CG resource instance for scheduling the UL data transmitted in that instance, reducing overall efficiency which may be, as described above, a particular issue for delay-sensitive services such as URLLC and XR.

Accordingly, embodiments of the present disclosure seek to address and provide solutions to the above-described issue of the control information overhead associated with UE-based scheduling.

### Control Information Size Adaptation for UE-Based Scheduling

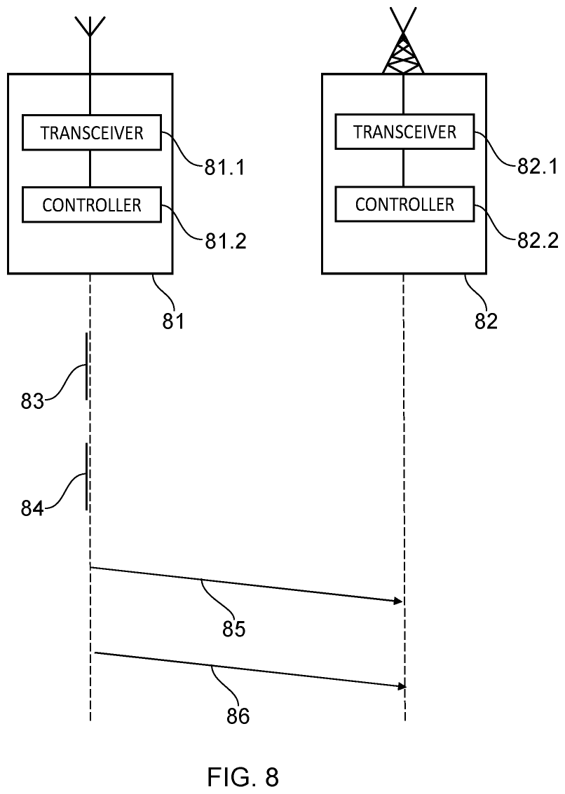

FIG. 8 shows a part schematic, part message flow diagram representation of a first wireless communications system comprising a communications device 81 and an infrastructure equipment 82 in accordance with at least some embodiments of the present technique. The communications device 81 is configured to transmit signals to and/or receive signals from the wireless communications network, for example, to and from the infrastructure equipment 82. Specifically, the communications device 81 may be configured to transmit data to and/or receive data from the wireless communications network (e.g. to/from the infrastructure equipment 82) via a wireless radio interface provided by the wireless communications network (e.g. the Uu interface between the communications device 81 and the Radio Access Network (RAN), which includes the infrastructure equipment 82). The communications device 81 and the infrastructure equipment 82 each comprise a transceiver (or transceiver circuitry) 81.1. 82.1. and a controller (or controller circuitry) 81.2. 82.2. Each of the controllers 81.2. 82.2 may be, for example, a microprocessor, a CPU, or a dedicated chipset, etc.

As shown in the example of FIG. 8, the transceiver circuitry 81.1 and the controller circuitry 81.2 of the communications device 81 are configured in combination to determine 83 that the communications device 81 has uplink data to transmit to the wireless communications network (e.g. to the infrastructure equipment 82), to determine 84, independently from the wireless communications network (e.g. without receiving any instruction or scheduling information from the infrastructure equipment 82), a plurality of periodically occurring instances of uplink resources of the wireless radio interface (e.g. preconfigured uplink resources such as configured grant (CG) resources) in which the uplink data is to be transmitted, wherein each of the instances of the uplink resources comprises at least a data resource, to transmit 85 to the wireless communications network (e.g. to the infrastructure equipment 82), in at least one of the instances of the uplink resources, a first part of the uplink data and full control information, and to transmit 86 to the wireless communications network (e.g. to the infrastructure equipment 82), in at least one other of the instances of the uplink resources, a second part of the uplink data and partial control information, wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value (i.e. these one or more values have changed from the previous time the at least one of the values was indicated by the communications device 81, either in full control information or partial control information).

Essentially, embodiments of the present technique propose that, for UE-based scheduling, a UE decides (independent from any instruction from the network) that it should transmit “full control information” on the control part/resource of a configured grant occasion at the beginning of a data transmission. In other words, the transmitting the full control information to the wireless communications network may be performed based on determining that a first predetermined condition has been satisfied, wherein the first predetermined condition may be that the first part of the uplink data that is transmitted in the at least one instance of the uplink resources in which the full control information is transmitted is the start of the uplink data. However, for subsequent transmissions, where possible, the UE transmits “partial control information” instead of the full control information, where the partial control information contains limited information compared to the full control information; e.g. at least those parameters that are most likely to change between adjacent slots.

Such parameters, which may include the resource allocation and MCS used for those subsequent parts of the data transmission, may indeed only necessitate the transmission of control information at all (and in this case, the partial control information), when they do indeed change. Alternatively, the partial control information may be transmitted under other certain conditions in accordance with arrangements of embodiments of the present technique, such as any change in the channel, a change in the data size, or at the end of the data transmission, though such conditions are not limited to just these. Indeed, in some arrangements of embodiments of the present technique, the partial control information may even be transmitted in some instances at the start of the data transmission instead of the full control information; and in this case the network may assume in such arrangements that all other parameters not included in the partial control information are therefore unchanged from the last time a data transmission was received from that UE.

In other words, the transmitting the partial control information to the wireless communications network is performed based on determining that a second predetermined condition has been satisfied, wherein the second predetermined condition may be that the communications device determines that a value of at least one of the scheduling parameters is to be changed from the previous instance of the uplink resources in which a part of the uplink data was transmitted. Alternatively, or in addition, the second predetermined condition may be that the communications device determines that more than a predetermined number of instances have passed since the communications device last transmitted partial control information. Alternatively, or in addition, the second predetermined condition may be that the communications device determines that more than a predetermined amount of time has passed since the communications device last transmitted partial control information—though such a condition may not be configured for stationary UEs such as smart meters, which do not move and thus may not require the changing of scheduling parameters even when a long time has passed.

Hence, embodiments of the present disclosure proposes that at least two different payload sizes are defined for control information transmitted by a UE operating in accordance with a UE-based scheduling mode. Here, this control information may be carried on a control part/resource embedded in the data part (PUSCH) of the uplink resource instances. or transmitted separately in the PUCCH (e.g. as shown in the example of FIG. 7). Those skilled in the art would appreciate that some parameters associated with a UE's uplink data transmission may be configured by RRC signalling, but in this proposal, only dynamically changing parameters which may be independently determined and indicated by the UE operating in accordance with the UE-based scheduling mode are considered.

Obviously, given the UE is operating in the UE-based scheduling mode independently from the network, the network/gNB is not aware which uplink control information (UCI) size the UE has transmitted in each slot/occasion. As such, the gNB has to monitor for and blindly decode (at least, as multiple different sizes of the partial control information may be transmitted) two possible payload sizes in each slot/occasion. In other words, the infrastructure equipment may be configured to monitor for both of full control information and partial control information in each of the instances of the uplink resources.

If UCI of a first payload size and comprising the full control information is received within an uplink transmission occasion, then the gNB will store and keep the control information in its entirety for decoding the current and subsequent data (PUSCH). In other words, the infrastructure equipment may be configured to overwrite, upon receiving the full control information from the communications device, a previously stored configuration of full control information with the newly received full control information. However, if UCI of a second payload size and comprising partial control information is received within an uplink transmission occasion, then the gNB will replace or update only the changed transmission parameters with the new corresponding new values for decoding the current and subsequent data (PUSCH). In other words, the infrastructure equipment may be configured to overwrite, upon receiving the partial control information from the communications device, one or more portions of a previously stored configuration of full control information with the newly received partial control information, wherein the one or more portions of the previously stored configuration of full control information which are overwritten correspond to the one or more of the plurality of scheduling parameters that are indicated by the newly received partial control information. To enable the gNB to test confirm successful blind decoding, the UE may attach a cyclic redundancy code (CRC) checksum (e.g., 8-bit CRC) in the UCI payload in order to enable the detection of errors at the gNB.

As an example, the full control information can contain the following parameters (though in embodiments of the present technique, the full control information is not limited to/required to contain all of such parameters listed below):
FDRA: Frequency-domain resource allocation (FDRA) in terms of number of PRBs (i.e., starting and ending PRBs) in which the uplink data is transmitted;
TDRA: Time-domain resource allocation (TDRA) in terms of number of orthogonal frequency division multiplexing (OFDM) symbols (i.e., starting and ending symbols) in which the uplink data is transmitted;
Modulation and coding scheme (MCS): Modulation (QPSK, 16 QAM, etc.) and coding rate used for the uplink data;
New data indicator (NDI): Indicating whether the uplink data is new data or a re-transmission of previously transmitted data;
Redundancy version (RV): Indicating (via the RV indicated) which set of bits in the encoded codeword are transmitted;
HARQ-related: e.g. the HARQ process number of the HARQ process used for the uplink data;
Multiple-antenna-related: Indication of demodulation reference signal (DMRS, antenna port(s), precoding information, SRS, etc.; and
Continuing/end of data: UE informs the gNB whether or not it will continue to schedule subsequent data in subsequent instances of the uplink resources after transmitting uplink data in the current instance.

As an example of the partial control information, the partial control information can contain a small(er) number of parameters as compared to the full control information. These parameters may be at least those that are most likely to change between adjacent transmissions, or indeed those which have changed since the previous transmission. Again, though in embodiments of the present technique, the partial control information is not limited to/required to contain all of such parameters listed below, and indeed there may be multiple sizes of partial control information comprising more of fewer parameters than those listed below, such parameters indicated by the partial control information may comprise, for example:
FDRA: Frequency-domain resource allocation (FDRA) in terms of number of PRBs (i.e., starting and ending PRBs) in which the uplink data is transmitted;
Modulation and coding scheme (MCS): Modulation (QPSK, 16 QAM, etc.) and coding rate used for the uplink data;
New data indicator (NDI): Indicating whether the uplink data is new data or a re-transmission of previously transmitted data;
Continuing/end of data: UE informs the gNB whether or not it will continue to schedule subsequent data in subsequent instances of the uplink resources after transmitting uplink data in the current instance; and
Indicator of included parameters: Bit-map (which may be at the start of the partial control information payload) indicating which parameters or set of parameters are included in the payload, i.e., those parameters that have changed.

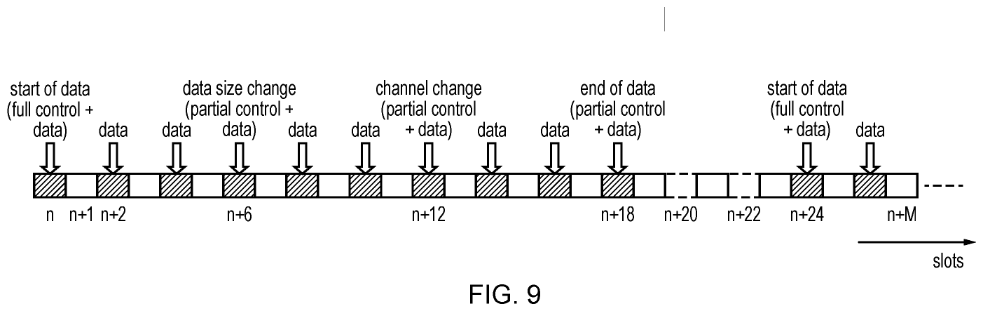

FIG. 9 illustrates an example of the adaptation of control information (payload) size for UE-based scheduling in accordance with embodiments of the present technique. As shown in FIG. 9, the CG resource occasions are configured with periodicity of every second slot; with those slots for which the CG resource occasions are not configured (e.g. slot n+1, slot n+3) being unshaded in FIG. 9, while those slots for which the CG resource occasions are configured being either shaded black when the UE utilises them to transmit uplink data (e.g. slot n, slot n+2) or having dashed outlines when the UE does not use them to transmit data, or no data is available (e.g. slot n+22, slot n=22).

In the example of FIG. 9, at slot n, in addition to starting transmission of the uplink data, the UE also transmits full control information in the control part/resource of the CG resource in slot n, where the full control information transmitted in the control part informs the network about the resource allocation for the PUSCH-and indeed, the control part may be embedded in this PUSCH. The control information also indicates the scheduling parameters for the portion of the data transmission transmitted in that CG resource in slot n.

The UE then continues to transmit only the uplink data parts in the subsequent resources (or slots) in this example, with the same parameters as those indicated by the full control information and used for the start of the transmission. However, at slot n+6, the UE notices that it has to transmit more data than in previous resource instances in order to keep up with the throughput/latency of the data. Hence, the UE allocates more resources for the data part and includes the new resource allocation in the control part where the control part contains partial control information (which comprises, for example, an indication of the updated resource allocation, updated MCS, and the end of data indication which is set to false).

The UE then, in the example of FIG. 9, continues to transmit only the data part in the subsequent resources with the same parameters as the last control information. However, at slot n+12, the UE notices that the channel has changed (e.g. in a TDD system, due to the channel reciprocity nature of such TDD systems, or on the basis of being informed as such by the network) and it has to update the MCS. Hence the UE changes the MCS, and includes the new MCS in the control part where the control part contains partial control information (which may again include an indication of an updated resource allocation, the new MCS, and the end of data indication which is set to false).

The UE then again continues to transmit only the data part in the subsequent resources with the same parameters as the last transmitted partial control information in slot n+12. However, at slot n+18, the UE notices that this is the last portion of the data to be transmitted, and must set the end of data indicator to true in the partial control information (which again may include indications of resource allocation and MCS, and with the end of data indication set to true). Thus, in order for the network to schedule resources in subsequent resource occasions, as well as the remaining resources in the occasion in slot n+18, to other UEs if needed, the UE transmits both the partial control information and data parts in this last transmission. The UE does not have data to transmit on occasions in slots n+20 and n+22. However, after a period of silence, the UE has data to transmit again on slot n+24 and repeats the same process as before, by transmitting full control information along with the first part of the data in the resource occasion in this slot.

In some arrangements of embodiments of the present disclosure, the full control information and partial control information could be carried on the same or different physical control resources (in terms of resource elements (REs)). In other words, the full control information and/or the partial control information may be transmitted either within a same control resource of the instances of the uplink resources or within different control resources of the instances of the uplink resources. Here, where the same control resource is used to transmit the full control information and/or the partial control information, the partial control information may be transmitted in a (smaller) portion of the control resources used for the full UCI. In some arrangements of embodiments of the present technique, it is also possible that the full control information informs the network/gNB (implicitly or explicitly) where the partial control information will be transmitted (in terms of resources) in the subsequent uplink resource instances/slots. i.e., the full control information may comprise a pointer to the resources of the partial control information. In other words, the full control information may comprise an indication of a location, within (one or more of) the at least one other of the instances of the uplink resources, within which the partial control information will be transmitted.

In some arrangements of embodiments of the present disclosure, the partial control information may comprise contain a descriptor/header/field, for example a bitmap, which is used to inform the gNB about which parameters are present in the partial control information. In other words, the partial control information may comprise an indicator which indicates the one or more of the plurality of scheduling parameters of which values are indicated by the partial control information.

Such a descriptor/header/field could improve the flexibility of the partial control information, so as to allow the inclusion/exclusion of at least some of the parameters each time the partial control information is transmitted, as well as more generally enabling a flexible and changeable size of the partial control information payload. This descriptor/header/field may always be included in the partial UCI (for example at the start of the payload). For example, a 2-bit bitmap can indicate four different sets of parameters listed in the full control information. In other words, the partial control information may be one of a plurality of sets of partial control information, each of the sets of partial control information comprising a different one or more of the plurality of scheduling parameters, where here, the indicator may be a bitmap that defines the set of the partial control information.

Those skilled in the art would appreciate that multiple parameters (i.e. those which are most commonly changing and thus required to be signalled in the partial control information) may be included within multiple sets, so as to solve a potential issue in the UE needing to update multiple parameters which may otherwise be included within different predefined sets of partial control information. In other words, one or more of the plurality of scheduling parameters may be comprised within at least two of the plurality of sets of partial control information. In some cases, if two less commonly changing parameters need updating, the UE may have to transmit two different sets of partial control information, which may be inefficient.

An alternative in such a case in accordance with some arrangements of embodiments of the present technique, where for example a certain number of scheduling parameters change (but not at a time where full control information may be transmitted otherwise), the UE may determine that it should transmit the full control information anyway. In other words, the transmitting the full control information to the wireless communications network may be performed based on determining that a first predetermined condition has been satisfied, wherein the first predetermined condition may be that the communications device determines that values of a threshold number of the scheduling parameters are to be changed from the previous instance of the uplink resources in which a part of the uplink data was transmitted.

Another alternative solution in accordance with arrangements of embodiments of the present technique is that, instead of (or indeed in addition to) such predetermined sets being configured, the UE may be configured to determine which parameters need to be signalled, and to construct its own partial control information signal of any required size comprising these determined parameters. In other words, the communications device may be configured to select the one or more of the plurality of scheduling parameters (e.g. based on those one or more parameters having changed, or based on a determined coverage change, or based on receiving one or more NACKs from the wireless communications network) of which values are to be indicated by the partial control information.

The UE may then include in this constructed partial control information, as the descriptor/header/field, a N bit indicator, where there are N possible parameters that the partial control information could indicate (which may be the same N parameters indicated by the full control information), each bit of the N bits therefore indicating for that parameter whether such a changed value of that parameter is included in the constructed partial control information. In other words, the indicator may be a bit string comprising a plurality of bits, each of the bits being associated with one of the plurality of scheduling parameters and indicating whether or not the one of the scheduling parameters is comprised within the partial control information. Again, this N bit indicator may always be included in the partial UCI (for example at the start of the payload) in order to ensure maximum flexibility from the point of view of the UE's construction of the partial control information. In some arrangements, it may be the case that not all N parameters have a bit associated with them in this indicator, which may in such a case therefore be considered an M bit indicator where M<N, should such features (e.g. FDRA) always be included in the partial control information and thus do not need to be signalled.

In order to handle error propagation, for example if partial information cannot be decoded at the gNB for successive transmissions, a UE may be required in some arrangements of embodiments of the present technique to monitor DL acknowledgement feedback. In other words, the communications device may be configured to monitor for an acknowledgement signal to be received from the wireless communications network, the acknowledgement signal indicating that the partial control information has been successfully received by the wireless communications network.

Such DL acknowledgement feedback may, for example, be implemented in a similar manner to Downlink Feedback Information (DFI) signaling defined for NR-U (NR-Unlicensed) and transmitted by the gNB for the corresponding HARQ processes. The UE may be configured to determine, based on the received (or not received) DL acknowledgment feedback, whether there are successive NACKs. If so, in at least some arrangements of embodiments of the present technique, the UE can switch to transmitting the full control information in a next resource instance (or a next resource instance in which the UE also transmits UL data). In other words, the communications device may be configured to determine that the acknowledgement signal has not been received and therefore determining that the partial control information has not been successfully received by the wireless communications network, and subsequently to transmit, to the wireless communications network, full control information instead of the partial control information which was not successfully received by the wireless communications network.

In other arrangements of embodiments of the present technique, the UE may be able to enable the handling of error control by maintaining the transmission of the full control information periodically. In other words, the transmitting the full control information to the wireless communications network may be performed in accordance with a set periodicity. This periodic full control information transmission may be a period defined in terms of time, and/or a period defined in terms of UL resource occasions, and/or a period defined by the transmission of the partial control information; i.e. full control information may be transmitted at least after a few transmissions (i.e. every N transmissions) of the partial control information. In other words, the set periodicity may define a predetermined number of instances of the uplink resources between instances of the uplink resources in which full control information is transmitted by the communications device. Alternatively, or in addition, the set periodicity may define a predetermined amount of time between transmissions of full control information by the communications device. Alternatively, or in addition, the set periodicity may define a predetermined number of times the communications device is to transmit partial control information between transmissions of full control information by the communications device.

In some such arrangements of embodiments of the present technique where the full control information is transmitted periodically by the UE, the transmission periodicity of the full control information can be configured by the network/gNB, so that the UE and gNB are aligned as when to expect the transmission of the full control information-thus enabling more straightforward and efficient monitoring and decoding of the full control information at the gNB. In other words, the communications device may be configured to receive, from the wireless communications network, an indication of the set periodicity. In other such arrangements of embodiments of the present technique where the full control information is transmitted periodically by the UE, the transmission periodicity of the full control information may be determined by the UE, independently from the network. The UE may subsequently provide an indication of this set periodicity to the network/gNB, but alternatively, the UE might inform the network/gNB of the set periodicity, meaning that the network/gNB is required to blindly decode for the transmitted control information. Those skilled in the art would appreciate that, where the UE receives the indication of the set periodicity from the network/gNB, it would not then independently determine the (i.e. a different) set periodicity itself.

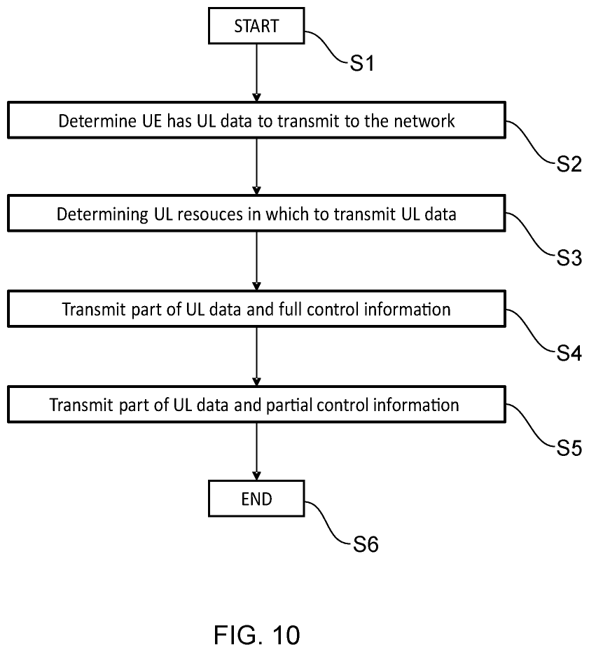

FIG. 10 shows a flow diagram illustrating an example process of communications in a communications system in accordance with embodiments of the present technique. The process shown by FIG. 10 is a method of operating a communications device configured to transmit signals to and/or to receive signals from a wireless communications network (e.g. to or from an infrastructure equipment of the wireless communications network), the communications device operating in accordance with a communications device based scheduling mode in order to transmit uplink data.

The method begins in step S1. The method comprises, in step S2, determining that the communications device has uplink data to transmit to the wireless communications network. In step S3, the process comprises determining, independently from the wireless communications network, a plurality of periodically occurring instances of uplink resources of the wireless radio interface in which the uplink data is to be transmitted, wherein each of the instances of the uplink resources comprise at least a data resource. In step S4, the method comprises transmitting to the wireless communications network, in at least one of the instances of the uplink resources, a first part of the uplink data and full control information, wherein the full control information indicates values of each of a plurality of scheduling parameters in accordance with which the first part of the uplink data is to be transmitted. Then, in step S5, the process comprises transmitting to the wireless communications network, in at least one other of the instances of the uplink resources, a second part of the uplink data and partial control information, wherein the partial control information indicates values for one or more of the plurality of scheduling parameters in accordance with which the second part of the uplink data is to be transmitted, wherein at least one of the values indicated by the partial control information is a changed value. The process ends in step S6.

Those skilled in the art would appreciate that the method shown by FIG. 10 may be adapted in accordance with embodiments of the present technique. For example, other intermediate steps may be included in this method, or the steps may be performed in any logical order. Though embodiments of the present technique have been described largely by way of the example communications system shown in FIG. 8, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device configured to transmit signals to and/or to receive signals from a wireless communications network via a wireless radio interface provided by the wireless communications network, the method comprising
determining that the communications device has uplink data to transmit to the wireless communications network,
determining, independently from the wireless communications network, a plurality of periodically occurring instances of uplink resources of the wireless radio interface in which the uplink data is to be transmitted, wherein each of the instances of the uplink resources comprise at least a data resource,
transmitting to the wireless communications network, in at least one of the instances of the uplink resources, a first part of the uplink data and full control information, and
transmitting to the wireless communications network, in at least one other of the instances of the uplink resources, a second part of the uplink data and partial control information,
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.
Paragraph 2. A method according to Paragraph 1, wherein the full control information and/or the partial control information are each transmitted within a control resource embedded within the data resource.
Paragraph 3. A method according to Paragraph 1 or Paragraph 2, wherein the full control information and/or the partial control information are each transmitted within a control resource separate to the data resource.
Paragraph 4. A method according to any of Paragraphs 1 to 3, wherein the transmitting the full control information to the wireless communications network is performed based on determining that a first predetermined condition has been satisfied.
Paragraph 5. A method according to Paragraph 4, wherein the first predetermined condition is that the first part of the uplink data that is transmitted in the at least one instance of the uplink resources in which the full control information is transmitted is the start of the uplink data.
Paragraph 6. A method according to Paragraph 4 or Paragraph 5, wherein the first predetermined condition is that the communications device determines that values of a threshold number of the scheduling parameters are to be changed from the previous instance of the uplink resources in which a part of the uplink data was transmitted.
Paragraph 7. A method according to any of Paragraphs 1 to 6, wherein the transmitting the full control information to the wireless communications network is performed in accordance with a set periodicity.
Paragraph 8. A method according to Paragraph 7, wherein the set periodicity defines a predetermined number of instances of the uplink resources between instances of the uplink resources in which full control information is transmitted by the communications device.
Paragraph 9. A method according to Paragraph 7 or Paragraph 8, wherein the set periodicity defines a predetermined amount of time between transmissions of full control information by the communications device.
Paragraph 10. A method according to any of Paragraphs 7 to 9, wherein the set periodicity defines a predetermined number of times the communications device is to transmit partial control information between transmissions of full control information by the communications device.
Paragraph 11. A method according to any of Paragraphs 7 to 10, comprising
receiving, from the wireless communications network, an indication of the set periodicity.
Paragraph 12. A method according to any of Paragraphs 7 to 11, comprising
determining, independently from the wireless communications network, the set periodicity.
Paragraph 13. A method according to any of Paragraphs 1 to 12, wherein the transmitting the partial control information to the wireless communications network is performed based on determining that a second predetermined condition has been satisfied.
Paragraph 14. A method according to Paragraph 13, wherein the second predetermined condition is that the communications device determines that a value of at least one of the scheduling parameters is to be changed from the previous instance of the uplink resources in which a part of the uplink data was transmitted.
Paragraph 15. A method according to Paragraph 13 or Paragraph 14, wherein the second predetermined condition is that the communications device determines that more than a predetermined number of instances have passed since the communications device last transmitted partial control information.
Paragraph 16. A method according to any of Paragraphs 13 to 15, wherein the second predetermined condition is that the communications device determines that more than a predetermined amount of time has passed since the communications device last transmitted partial control information.
Paragraph 17. A method according to any of Paragraphs 1 to 16, wherein the full control information and the partial control information are transmitted within a same control resource of the instances of the uplink resources.
Paragraph 18. A method according to any of Paragraphs 1 to 17, wherein the full control information and the partial control information are transmitted within different control resources of the instances of the uplink resources.
Paragraph 19. A method according to any of Paragraphs 1 to 18, wherein the full control information comprises an indication of a location, within the at least one other of the instances of the uplink resources, within which the partial control information will be transmitted.
Paragraph 20. A method according to any of Paragraphs 1 to 19, wherein the partial control information comprises an indicator which indicates the one or more of the plurality of scheduling parameters of which values are indicated by the partial control information.
Paragraph 21. A method according to Paragraph 20, wherein the partial control information is one of a plurality of sets of partial control information, each of the sets of partial control information comprising a different one or more of the plurality of scheduling parameters.
Paragraph 22. A method according to Paragraph 21, wherein the indicator is a bitmap that defines the set of the partial control information.
Paragraph 23. A method according to Paragraph 21 or Paragraph 22, wherein one or more of the plurality of scheduling parameters are comprised within at least two of the plurality of sets of partial control information.
Paragraph 24. A method according to any of Paragraphs 20 to 23, wherein the communications device selects the one or more of the plurality of scheduling parameters of which values are to be indicated by the partial control information.
Paragraph 25. A method according to Paragraph 24, wherein the indicator is a bit string comprising a plurality of bits, each of the bits being associated with one of the plurality of scheduling parameters and indicating whether or not the one of the scheduling parameters is comprised within the partial control information.
Paragraph 26. A method according to any of Paragraphs 1 to 25, comprising monitoring for an acknowledgement signal to be received from the wireless communications network, the acknowledgement signal indicating that the partial control information has been successfully received by the wireless communications network.
Paragraph 27. A method according to Paragraph 26, comprising
determining that the acknowledgement signal has not been received and therefore determining that the partial control information has not been successfully received by the wireless communications network, and
transmitting, to the wireless communications network, full control information instead of the partial control information which was not successfully received by the wireless communications network.
Paragraph 28. A method according to any of Paragraphs 1 to 27, wherein the plurality of periodically occurring instances of uplink resources are preconfigured uplink resource instances.
Paragraph 29. A method according to any of Paragraphs 1 to 28, wherein the preconfigured uplink resource instances are configured grant resource instances.
Paragraph 30. A communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network,
to determine, independently from the wireless communications network, a plurality of periodically occurring instances of uplink resources of the wireless radio interface in which the uplink data is to be transmitted, wherein each of the instances of the uplink resources comprise at least a data resource,
to transmit to the wireless communications network, in at least one of the instances of the uplink resources, a first part of the uplink data and full control information, and
to transmit to the wireless communications network, in at least one other of the instances of the uplink resources, a second part of the uplink data and partial control information,
wherein the full control information indicates values of each of a plurality of scheduling parameters with in accordance which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.
Paragraph 31. Circuitry for a communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network,
to determine, independently from the wireless communications network, a plurality of periodically occurring instances of uplink resources of the wireless radio interface in which the uplink data is to be transmitted, wherein each of the instances of the uplink resources comprise at least a data resource,
to transmit to the wireless communications network, in at least one of the instances of the uplink resources, a first part of the uplink data and full control information, and
to transmit to the wireless communications network, in at least one other of the instances of the uplink resources, a second part of the uplink data and partial control information,
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.
Paragraph 32. A method of operating an infrastructure equipment forming part of a wireless communications network, the infrastructure equipment being configured to transmit signals to and/or to receive signals from a communications device via a wireless radio interface provided by the infrastructure equipment, the method comprising
receiving from the communications device, in at least one instance of a plurality of periodically occurring instances of uplink resources of the wireless radio interface, a first part of uplink data and full control information, wherein each of the instances of the uplink resources comprise at least a data resource, and
receiving from the communications device, in at least one other of the instances of the uplink resources, a second part of the uplink data and partial control information,
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.
Paragraph 33. A method according to Paragraph 32, wherein the full control information and/or the partial control information are each received within a control resource embedded within the data resource.
Paragraph 34. A method according to Paragraph 32 or Paragraph 33, wherein the full control information and/or the partial control information are each received within a control resource separate to the data resource.
Paragraph 35. A method according to any of Paragraphs 32 to 34, wherein the full control information is received from the communications device when a first predetermined condition has been satisfied.
Paragraph 36. A method according to Paragraph 35, wherein the first predetermined condition is that the first part of the uplink data that is received in the at least one instance of the uplink resources in which the full control information is received is the start of the uplink data.
Paragraph 37. A method according to Paragraph 35 or Paragraph 36, wherein the first predetermined condition is that a threshold number of the scheduling parameters are to be changed from the previous instance of the uplink resources in which a part of the uplink data was received.
Paragraph 38. A method according to any of Paragraphs 32 to 37, wherein the full control information is received from the communications device in accordance with a set periodicity.
Paragraph 39. A method according to Paragraph 38, wherein the set periodicity defines a predetermined number of instances of the uplink resources between instances of the uplink resources in which full control information is transmitted by the communications device.
Paragraph 40. A method according to Paragraph 38 or Paragraph 39, wherein the set periodicity defines a predetermined amount of time between transmissions of full control information by the communications device.
Paragraph 41. A method according to any of Paragraphs 38 to 40, wherein the set periodicity defines a predetermined number of times the communications device is to transmit partial control information between transmissions of full control information by the communications device.
Paragraph 42. A method according to any of Paragraphs 38 to 41, comprising
transmitting. to the communications device, an indication of the set periodicity.
Paragraph 43. A method according to any of Paragraphs 38 to 42, wherein the set periodicity is determined by the communications device independently from the wireless communications network.
Paragraph 44. A method according to any of Paragraphs 32 to 43, wherein the partial control information is received from the communications device when a second predetermined condition has been satisfied.
Paragraph 45. A method according to Paragraph 44, wherein the second predetermined condition is a value of at least one of the scheduling parameters is to be changed from the previous instance of the uplink resources in which a part of the uplink data was received.
Paragraph 46. A method according to Paragraph 44 or Paragraph 45, wherein the second predetermined condition is more than a predetermined number of instances have passed since the communications device last transmitted partial control information.
Paragraph 47. A method according to any of Paragraphs 44 to 46, wherein the second predetermined condition is that more than a predetermined amount of time has passed since the communications device last transmitted partial control information.
Paragraph 48. A method according to any of Paragraphs 32 to 47, wherein the full control information and the partial control information are received within a same control resource of the instances of the uplink resources.
Paragraph 49. A method according to any of Paragraphs 32 to 48, wherein the full control information and the partial control information are received within different control resources of the instances of the uplink resources.
Paragraph 50. A method according to any of Paragraphs 32 to 49, wherein the full control information comprises an indication of a location, within the at least one other of the instances of the uplink resources, within which the partial control information will be transmitted.
Paragraph 51. A method according to any of Paragraphs 32 to 50, wherein the partial control information comprises an indicator which indicates the one or more of the plurality of scheduling parameters of which values are indicated by the partial control information.
Paragraph 52. A method according to Paragraph 51, wherein the partial control information is one of a plurality of sets of partial control information, each of the sets of partial control information comprising a different one or more of the plurality of scheduling parameters.
Paragraph 53. A method according to Paragraph 52, wherein the indicator is a bitmap that defines the set of the partial control information.
Paragraph 54. A method according to Paragraph 52 or Paragraph 53, wherein one or more of the plurality of scheduling parameters are comprised within at least two of the plurality of sets of partial control information.
Paragraph 55. A method according to any of Paragraphs 51 to 54, wherein the one or more of the plurality of scheduling parameters of which values are to be indicated by the partial control information are selected by the communications device.
Paragraph 56. A method according to Paragraph 55, wherein the indicator is a bit string comprising a plurality of bits, each of the bits being associated with one of the plurality of scheduling parameters and indicating whether or not the one of the scheduling parameters is comprised within the partial control information.
Paragraph 57. A method according to any of Paragraphs 32 to 56, comprising
transmitting to the communications device, if the partial control information has been successfully received by the infrastructure equipment, an acknowledgement signal indicating that the partial control information has been successfully received by the infrastructure equipment.
Paragraph 58. A method according to Paragraph 57, comprising
receiving from the communications device, based on the acknowledgement signal not having been received by the communications device in response to the partial control information having been transmitted by the communications device, full control information instead of the partial control information.
Paragraph 59. A method according to any of Paragraphs 32 to 58, comprising
monitoring for both of full control information and partial control information in each of the instances of the uplink resources.
Paragraph 60. A method according to any of Paragraphs 32 to 59, comprising
overwriting, upon receiving the full control information from the communications device, a previously stored configuration of full control information with the newly received full control information.
Paragraph 61. A method according to any of Paragraphs 32 to 60, comprising
overwriting, upon receiving the partial control information from the communications device, one or more portions of a previously stored configuration of full control information with the newly received partial control information, wherein the one or more portions of the previously stored configuration of full control information which are overwritten correspond to the one or more of the plurality of scheduling parameters that are indicated by the newly received partial control information.
Paragraph 62. A method according to any of Paragraphs 32 to 61, wherein the plurality of periodically occurring instances of uplink resources are preconfigured uplink resource instances.
Paragraph 63. A method according to any of Paragraphs 32 to 62, wherein the preconfigured uplink resource instances are configured grant resource instances.
Paragraph 64. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to receive from the communications device, in at least one instance of a plurality of periodically occurring instances of uplink resources of the wireless radio interface, a first part of uplink data and full control information, wherein each of the instances of the uplink resources comprise at least a data resource, and
to receive from the communications device, in at least one other of the instances of the uplink resources, a second part of the uplink data and partial control information,
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.
Paragraph 65. Circuitry for an infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to receive from the communications device, in at least one instance of a plurality of periodically occurring instances of uplink resources of the wireless radio interface, a first part of uplink data and full control information, wherein each of the instances of the uplink resources comprise at least a data resource, and
to receive from the communications device, in at least one other of the instances of the uplink resources, a second part of the uplink data and partial control information.
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.
Paragraph 66. A wireless communications system comprising a communications device according to Paragraph 30 and an infrastructure equipment according to Paragraph 64.
Paragraph 67. A computer program comprising instructions which, when loaded onto a computer. cause the computer to perform a method according to any of Paragraphs 1 to 29 or any of Paragraphs 32 to 63.
Paragraph 68. A non-transitory computer-readable storage medium storing a computer program according to Paragraph 67.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

References
[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] RP-190726, “Physical layer enhancements for NR ultra-reliable and low latency communication (URLLC)”, Huawei, HiSilicon, RAN#83, March 2019.
[4] RP-201310, “Revised WID: Enhanced Industrial Internet of Things (IoT) and ultra-reliable and low latency communication (URLLC) support for NR,” Nokia, Nokia Shanghai Bell, RAN#88e, July 2020.
[5] European patent application with publication number EP3837895.
[6] European patent application number EP21204071.1.

1. A method of operating a communications device configured to transmit signals to and/or to receive signals from a wireless communications network via a wireless radio interface provided by the wireless communications network, the method comprising
determining that the communications device has uplink data to transmit to the wireless communications network,
determining, independently from the wireless communications network, a plurality of periodically occurring instances of uplink resources of the wireless radio interface in which the uplink data is to be transmitted, wherein each of the instances of the uplink resources comprise at least a data resource,
transmitting to the wireless communications network, in at least one of the instances of the uplink resources, a first part of the uplink data and full control information, and
transmitting to the wireless communications network, in at least one other of the instances of the uplink resources, a second part of the uplink data and partial control information,
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.

2. A method according to claim 1, wherein the full control information and/or the partial control information are each transmitted within a control resource embedded within the data resource.

3. A method according to claim 1, wherein the full control information and/or the partial control information are each transmitted within a control resource separate to the data resource.

4. A method according to claim 1, wherein the transmitting the full control information to the wireless communications network is performed based on determining that a first predetermined condition has been satisfied.

5. A method according to claim 4, wherein the first predetermined condition is that the first part of the uplink data that is transmitted in the at least one instance of the uplink resources in which the full control information is transmitted is the start of the uplink data.

6. A method according to claim 4, wherein the first predetermined condition is that the communications device determines that values of a threshold number of the scheduling parameters are to be changed from the previous instance of the uplink resources in which a part of the uplink data was transmitted.

7. A method according to claim 1, wherein the transmitting the full control information to the wireless communications network is performed in accordance with a set periodicity.

8. A method according to claim 7, wherein the set periodicity defines a predetermined number of instances of the uplink resources between instances of the uplink resources in which full control information is transmitted by the communications device.

9. A method according to claim 7, wherein the set periodicity defines a predetermined amount of time between transmissions of full control information by the communications device.

10. A method according to claim 7, wherein the set periodicity defines a predetermined number of times the communications device is to transmit partial control information between transmissions of full control information by the communications device.

11. A method according to claim 7, comprising
receiving, from the wireless communications network, an indication of the set periodicity.

12. A method according to claim 7, comprising
determining, independently from the wireless communications network, the set periodicity.

13. A method according to claim 1, wherein the transmitting the partial control information to the wireless communications network is performed based on determining that a second predetermined condition has been satisfied.

14. A method according to claim 13, wherein the second predetermined condition is that the communications device determines that a value of at least one of the scheduling parameters is to be changed from the previous instance of the uplink resources in which a part of the uplink data was transmitted.

15. A method according to claim 13, wherein the second predetermined condition is that the communications device determines that more than a predetermined number of instances have passed since the communications device last transmitted partial control information.

16. A method according to claim 13, wherein the second predetermined condition is that the communications device determines that more than a predetermined amount of time has passed since the communications device last transmitted partial control information.

17. A method according to claim 1, wherein the full control information and the partial control information are transmitted within a same control resource of the instances of the uplink resources.

18. A method according to claim 1, wherein the full control information and the partial control information are transmitted within different control resources of the instances of the uplink resources.

19.-29. (canceled)

30. A communications device comprising
transceiver circuitry configured to transmit signals to and/or to receive signals from a wireless communications network via a wireless radio interface provided by the wireless communications network, and
controller circuitry configured in combination with the transceiver circuitry
to determine that the communications device has uplink data to transmit to the wireless communications network,
to determine, independently from the wireless communications network, a plurality of periodically occurring instances of uplink resources of the wireless radio interface in which the uplink data is to be transmitted, wherein each of the instances of the uplink resources comprise at least a data resource,
to transmit to the wireless communications network, in at least one of the instances of the uplink resources, a first part of the uplink data and full control information, and
to transmit to the wireless communications network, in at least one other of the instances of the uplink resources, a second part of the uplink data and partial control information,
wherein the full control information indicates values of each of a plurality of scheduling parameters with in accordance which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.

31.-63. (canceled)

64. An infrastructure equipment forming part of a wireless communications network, the infrastructure equipment comprising
transceiver circuitry configured to transmit signals to and/or to receive signals from a communications device via a wireless radio interface provided by the infrastructure equipment, and
controller circuitry configured in combination with the transceiver circuitry
to receive from the communications device, in at least one instance of a plurality of periodically occurring instances of uplink resources of the wireless radio interface, a first part of uplink data and full control information, wherein each of the instances of the uplink resources comprise at least a data resource, and
to receive from the communications device, in at least one other of the instances of the uplink resources, a second part of the uplink data and partial control information,
wherein the full control information indicates values of each of a plurality of scheduling parameters in accordance with which the first part of the uplink data is to be transmitted, and the partial control information indicates values for one or more of the plurality of scheduling parameters in accordance with which the second part of the uplink data is to be transmitted, wherein at least one of the values indicated by the partial control information is a changed value.

65.-68. (canceled)
